(19) United States
(12) Patent Application Publication
(10) Pub. No.: US 2016/0349603 A1
(43) Pub. Date: Dec. 1, 2016

(54) DISPLAY SYSTEM

(71) Applicant: HON HAI PRECISION INDUSTRY CO., LTD., New Taipei (TW)

(72) Inventor: JEN-TSORNG CHANG, New Taipei (TW)

(21) Appl. No.: 14/820,155

(22) Filed: Aug. 6, 2015

(30) Foreign Application Priority Data
May 27, 2015 (CN) 201510277209.7

(51) Int. Cl. G03B 21/14; G02B 3/00

(52) U.S. Cl. CPC G03B 21/142; G02B 3/0037

(57) ABSTRACT

A display system includes an image source device, a display device, and an optical projection device located between the display device and the image source device. The components of the optical projection device are rotatable relative to the image source device, and the display device can display a plurality of different images as the components of the optical projection device are rotated relative to the image source device. A combination image combining the different images can be viewed.

### FIELD

The subject matter herein generally relates to a display system, and particularly relates to a display system composed of multiple displays.

### BACKGROUND

A display system of large size, such as an outdoor display screen, is widely used. Because of limited size of a single display screen, the outdoor display screen is generally composed of several display units, and the several display units are used to show a whole picture together. Each display unit includes several borders which divide the overall picture.

### BRIEF DESCRIPTION OF THE DRAWINGS

Implementations of the present technology will now be described, by way of example only, with reference to the attached figures.

FIG. 1 is a cross-section view of an embodiment of a display system, and an optical projection device is towards an axial display area.

FIG. 2 is similar to FIG. 1, and the optical projection device is towards an upper display area.

FIG. 3 is similar to FIG. 1, and the optical projection device is towards an lower display area.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a display system. The display system includes an image source device, a display device, and an optical projection device located between the display device and the image source device. The components of the optical projection device are rotatable relative to the image source device, the display device displays a plurality of different images, and a combination image appears by the plurality of different images.

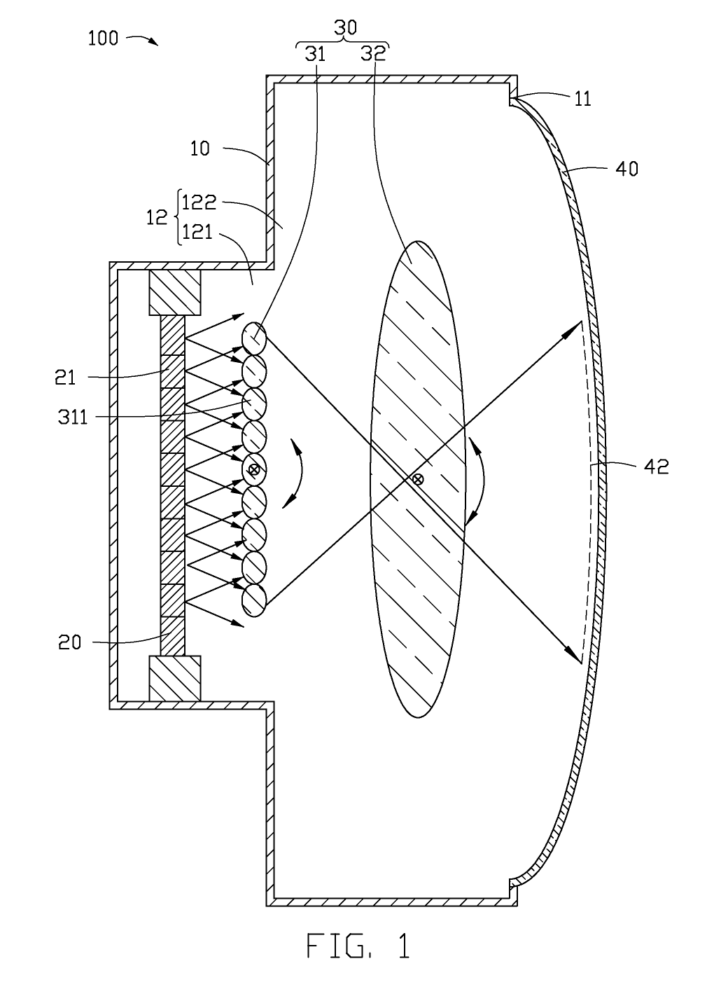

FIG. 1 illustrates a first embodiment of a display system 100. The display system 100 includes an enclosure 10, an image source device 20, a optical projection device 30, and a display device 40.

An opening 11 and a receiving space 12 communicating with the opening 11, are defined in the enclosure 10. In at least one embodiment, the receiving space 12 can include a first receiving portion 121 and a second receiving portion 122. The second receiving portion 122 has a larger size than the first receiving portion 121, and the second receiving portion 122 communicates with the opening 11.

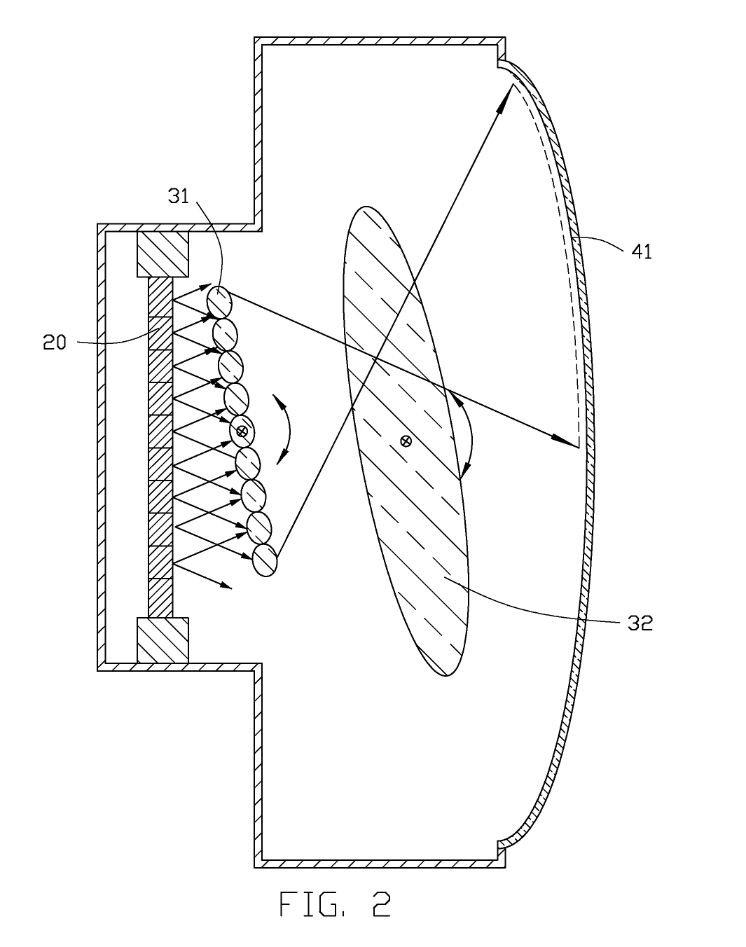

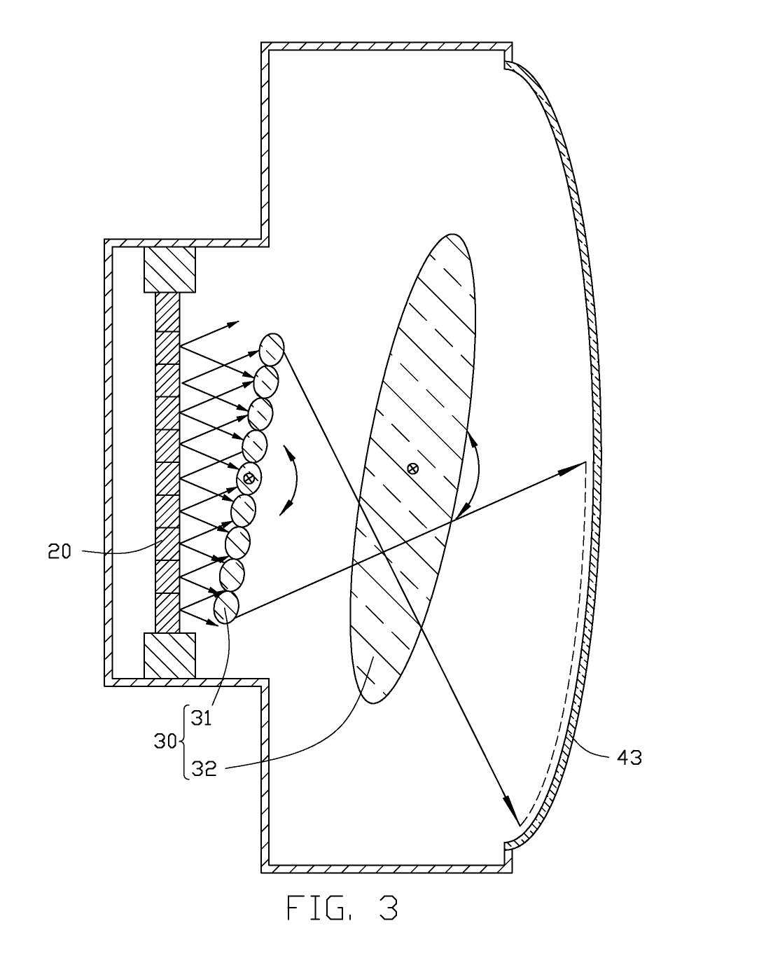

FIGS. 2 and 3 illustrate the image source device 20 being located on or in the first receiving portion 121. The image source device 20 is configured to offer a display image. In at least one embodiment, the image source device 20 is a flat display panel which is received in the first receiving portion 121 and secured to the enclosure 10. The image source device 20 can include a plurality of display units 21.

The optical projection device 30 is located on the front of the image source device 20 and includes a lens array 31 and a projection lens 32. The lens array 31 is received in the first receiving portion 121 and arranged at the front of the image source device 20. In at least one embodiment, the lens array 31 is separated from the image source device 20, and the lens array 31 can be a Lenticular Lens Array (LLA) or a micro-lens array. FIGS. 1-3 illustrate an LLA lens array 31, and the lens array 31 can include a plurality of lens units 311. Each of the plurality of lens units 311 corresponds to each of the plurality of display units 21. In at least one embodiment, the lens array 31 can be rotated about a first central axis that is substantially perpendicular to a cross-section of the plurality of lens units 311, and a rotation angle of the lens array 31 can be in a range between minus 5 degrees and plus 5 degrees.

The projection lens 32 is located in the second receiving portion 122 and arranged at the front of the plurality of lens units 311. In at least one embodiment, the projection lens 32 is a biconvex lens and can be rotatable about a second central axis that is substantially perpendicular to a cross-section of the projection lens 32. The second central axis is substantially parallel to the first central axis. In at least one embodiment, when the lens array 31 is rotated about the first central axis, the projection lens 32 is rotated about the second central axis at a same angle as the lens array 31 being rotated. A rotation angle of the projection lens 32 can be a range between minus 5 degrees and plus 5 degrees.

The display device 40 is located on the front of the projection lens 32. In at least one embodiment, the display device 40 is secured to the enclosure 10 and covers the opening 11. The display device 40 can be a common display screen or a touch display screen. In at least one embodiment, the display device 40 is curved away from the projection lens 32. The display device 40 can include a upper display area 41, a middle display area 42, and a lower display area 43, these display areas being contiguous and seamless.

In use, when the lens array 31 and the projection lens 32 are rotated towards the upper display area 41 (see FIG. 2), the image source device 20 offers a first image to be displayed on the upper display area 41, and the first image can be displayed on the upper display area 41. When the lens array 31 and the projection lens 32 are rotated towards the middle display area 42 (see FIG. 1), the image source device 20 offers a second image to be displayed on the middle display area 42, and the second image can be displayed on the middle display area 42. When the lens array 31 and the projection lens 32 are rotated towards the lower display area 43 (see FIG. 1), the image source device 20 offers a third image to be displayed on the lower display area 43, and a third image can be displayed on the lower display area 43. The lens array 31 and the projection lens 32 are continuously rotated, and a combination image composed of the first, second, and third images can be seen on the display device 40.

In other embodiments, the lens array 31 can be secured to the image source device 20, and the lens array 31 and the image source device 20 are together received in the first receiving portion 121, to be secured to the enclosure 10. Thereby, a rotation angle of the projection lens 32 can be in a range between minus 10 degrees and plus 10 degrees.

In other embodiments, the lens array 31 can be secured to the image source device 20, and the lens array 31 and the image source device 20 are together received in the first receiving portion 12. Thereby, the lens array 31 and the image source device 20 are together rotatable about the first central axis, and a rotation angle of lens array 31 and the image source device 20 can be in a range between minus 5 degrees and plus 5 degrees. In addition, when the projection lens 32 is secured to the display device 40, the rotation angle of lens array 31 and the image source device 20 can be in a range between minus 10 degrees and plus 10 degrees.

In other embodiments, the projection lens 32 is secured to the display device 40, and a rotation angle of the lens array 31 can be in a range between minus 10 degrees and plus 10 degrees.

In at least one embodiment, the image source device 20 can be a digital light precession projection or a laser scanning projection.

In at least one embodiment, the optical projection device 30 further includes a lens array (not shown) between the lens projection device 32 and the display device 40. The lens array is configured to create a spotlight of image information from the lens projection device 32. In at least one embodiment, the lens array can be an LLA or a micro-lens array.

In at least one embodiment, the above rotation angle can be adjusted according to the location of the lens array 31 and the lens projection device 32. Either the image source device 20 or the optical projection device 30 can be rotated relative to the other, the display device 40 being a curved surface. Thus, a size of the combination image, which is composed of the first, second, and third images, can be enlarged.

The embodiments shown and described above are only examples. Many details are often found in the art such as the other features of a display system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A display system comprising:
an enclosure defining a receiving space,
an image source device;
a display device; and
an optical projection device located between the display device and the image source device;
wherein the image source device, the display device, and the optical projection device are received in the receiving space, the optical projection device is rotatable relative to the image source device, and the display device is configured to display a plurality of different images forming a combination image.

2. The display system of claim 1, wherein an opening is defined in the enclosure and communicates with the receiving space, and the display device is secured to the enclosure and covers the opening.

3. The display system of claim 2, wherein the receiving space comprises a first receiving portion and a second receiving portion communicating with the opening, the optical projection device comprises a lens array and a projection lens, the lens array is received in the first receiving portion, and the projection lens is received in the second receiving portion.

4. The display system of claim 3, wherein the lens array is located between the image source device and the projection lens, and the image source device and the lens array are together received in the first receiving portion.

5. The display system of claim 4, wherein the image source device comprises a plurality of display units, and the lens array comprises a plurality of lens units corresponding to the plurality of display unit.

6. The display system of claim 5, wherein the lens array is rotatable about a first central axis that is substantially perpendicular to a cross-section of the plurality of lens units.

7. The display system of claim 6, wherein the projection lens is rotatable about a second central axis that is substantially perpendicular to a cross-section of the projection lens, and the second central axis is substantially parallel to the first central axis.

8. The display system of claim 7, wherein the image source device is secured to the enclosure, a rotation angle of the lens array is a range between minus 5 degrees and 5 degrees, and a rotation angle of the projection lens is a range between minus 5 degrees and 5 degrees.

9. The display system of claim 7, wherein the projection lens is secured to the display device, and a rotation angle of the lens array is a range between minus 10 degrees and 10 degrees.

10. The display system of claim 7, wherein the lens array is secured to the image source device, the lens array and the image source device are together received in the first receiving portion, the lens array and the image source device are together rotatable about the first central axis, and a rotation angle of lens array and the image source device is a range between minus 5 degrees and 5 degrees.

11. A display system comprising:
an image source device configured to offer at least two image sources;
a display device comprising at least two display areas; and
an optical projection device located between the display device and the image source device;
wherein one of the optical projection device and the image source device is rotatable relative to another of the optical projection device and the image source device, to display at least two images on the at least two display areas of the display device forming a combination image.

12. The display system of claim 11, further comprises an enclosure defining a receiving space, wherein the image source device, the display device, and the optical projection device are received in the receiving space, an opening is defined in the enclosure and communicates with the receiving space, and the display device is secured to the enclosure and covers the opening.

13. The display system of claim 12, wherein the receiving space comprises a first receiving portion and a second receiving portion communicating with the opening, the optical projection device comprises a lens array and a projection lens, the lens array is received in the first receiving portion, and the projection lens is received in the second receiving portion.

14. The display system of claim 13, wherein the lens array is located between the image source device and the projection lens, and the image source device and the lens array are together received in the first receiving portion.

15. The display system of claim 14, wherein the image source device comprises a plurality of display units, and the lens array comprises a plurality of lens units corresponding to the plurality of display unit.

16. The display system of claim 15, wherein the lens array is rotatable about a first central axis that is substantially perpendicular to a cross-section of the plurality of lens units.

17. The display system of claim 16, wherein the projection lens is rotatable about a second central axis that is substantially perpendicular to a cross-section of the projection lens, and the second central axis is substantially parallel to the first central axis.

18. The display system of claim 17, wherein the image source device is secured to the enclosure, a rotation angle of the lens array is a range between minus 5 degrees and 5 degrees, and a rotation angle of the projection lens is a range between minus 5 degrees and 5 degrees.

19. The display system of claim 11, wherein the at least two display areas comprises a upper display area, a middle display area and a lower display area, the middle display area is coupled to the upper display area and the lower display area, the optical projection device is rotatable relative to the image source device to display different images display on the upper display area, the middle display area and the lower display area, and the different images cooperatively defines the combination image.
